(19) United States
(12) Patent Application Publication
(10) Pub. No.: US 2016/0286716 A1
(43) Pub. Date: Oct. 6, 2016

(54) Chemical Distribution System

(71) Applicant: Jason McBride, Nibley, UT (US)

(72) Inventor: Jason McBride, Nibley, UT (US)

(21) Appl. No.: 14/676,967

(22) Filed: Apr. 2, 2015

(51) Int. Cl. A01C 23/04; A01C 23/00

(52) U.S. Cl. CPC A01C 23/042; A01C 23/007

(57) ABSTRACT

A chemical distribution system includes an irrigation unit that has a distribution pipe and a pump fluidly coupled to the distribution pipe. The pump urges a liquid through the distribution pipe and the irrigation unit delivers the fluid onto a plant crop. An injector is fluidly attached to the irrigation unit and the injector contains a chemical. The injector is oriented such that the chemical is gravity fed into the irrigation unit. The injector releases the chemical into the fluid urged by the pump such that the chemical and fluid mixture is delivered onto the plant crop.

### BACKGROUND OF THE DISCLOSURE

### Field of the Disclosure

The disclosure relates to chemical distribution devices and more particularly pertains to a new chemical distribution device for distributing the chemical onto a plant crop.

### SUMMARY OF THE DISCLOSURE

An embodiment of the disclosure meets the needs presented above by generally comprising an irrigation unit that has a distribution pipe and a pump fluidly coupled to the distribution pipe. The pump urges a liquid through the distribution pipe and the irrigation unit delivers the fluid onto a plant crop. An injector is fluidly attached to the irrigation unit and the injector contains a chemical. The injector is oriented such that the chemical is gravity fed into the irrigation unit. The injector releases the chemical into the fluid urged by the pump such that the chemical and fluid mixture is delivered onto the plant crop.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective in-use view of a chemical distribution system according to an embodiment of the disclosure.

FIG. 2 is a front perspective view of an embodiment of the disclosure.

FIG. 3 is a side perspective in-use view of an embodiment of the disclosure.

FIG. 4 is a right side view of an embodiment of the disclosure.

FIG. 5 is a left side view of an embodiment of the disclosure.

FIG. 6 is a perspective view of an alternative embodiment of the disclosure.

### DESCRIPTION OF THE PREFERRED EMBODIMENT

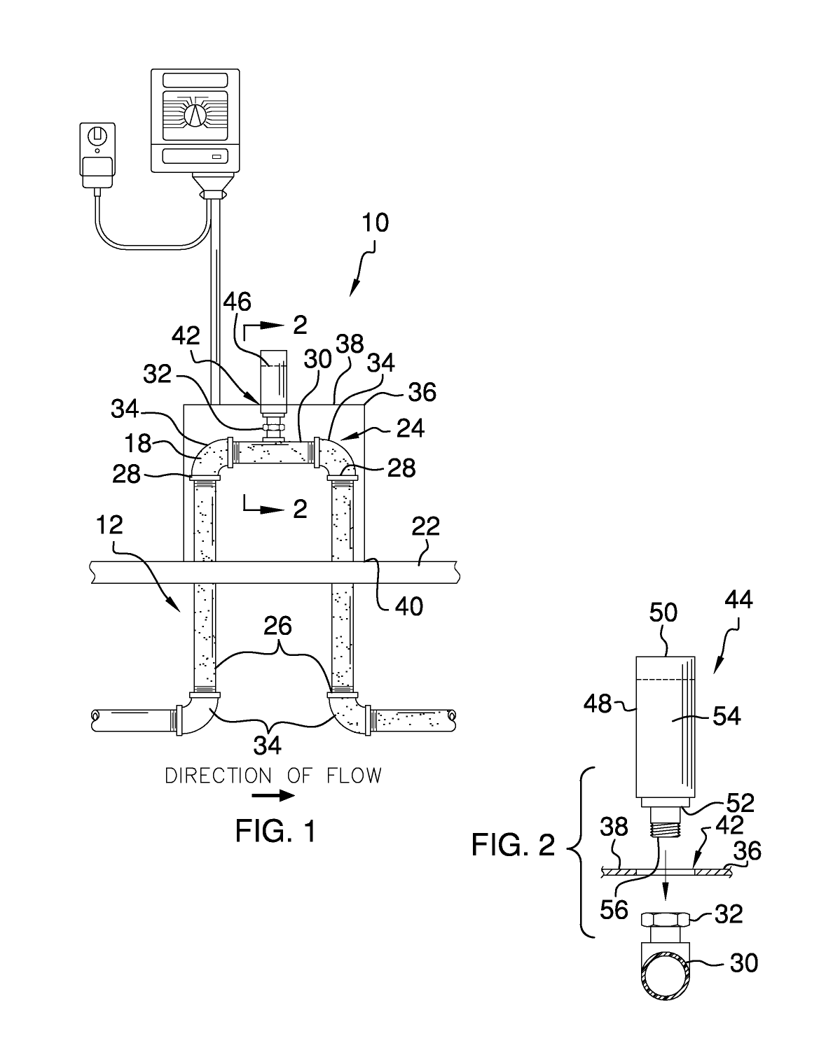

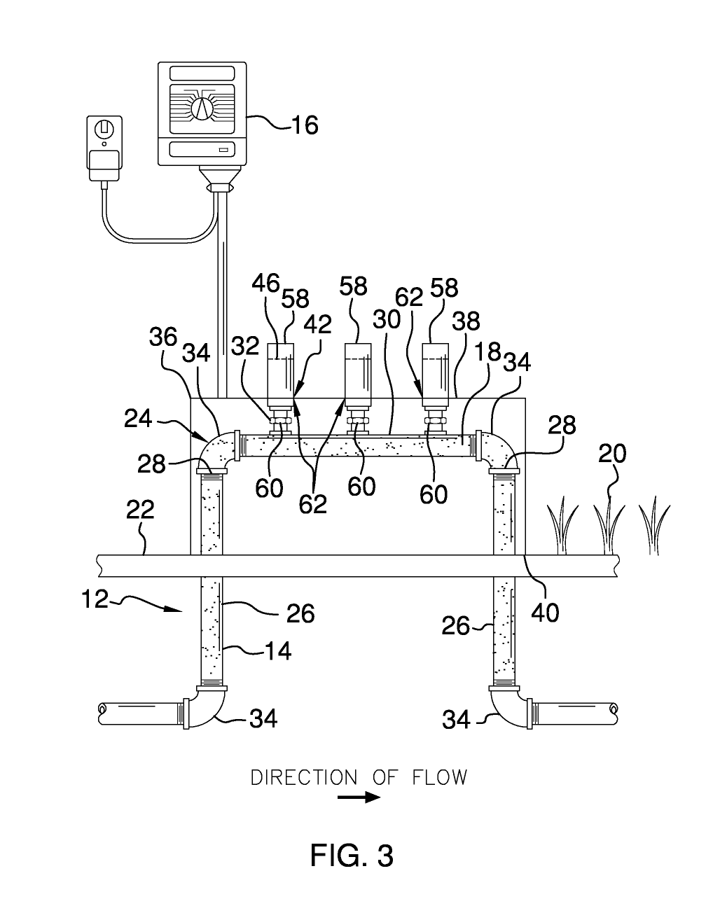

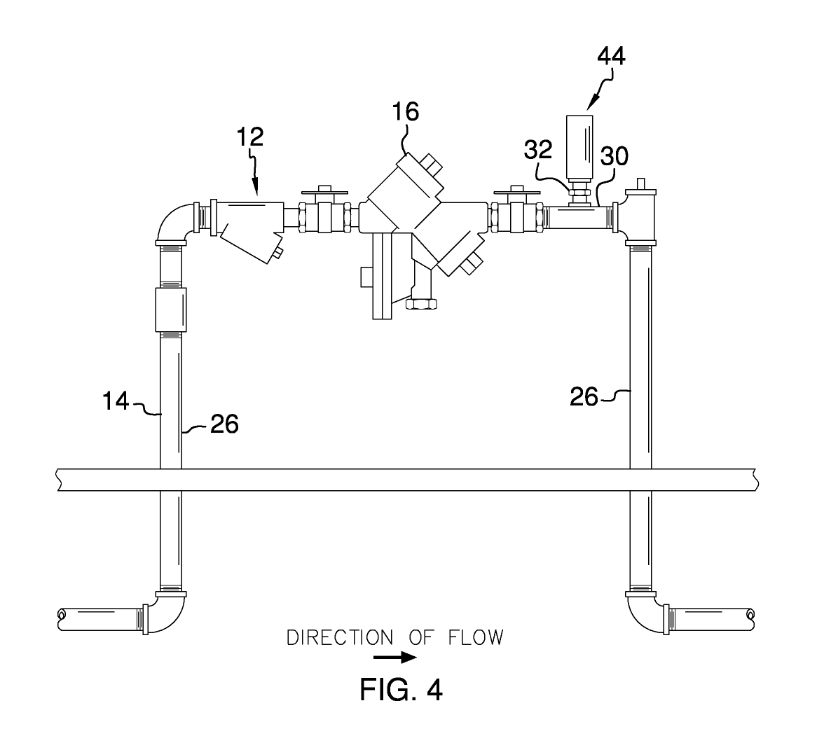

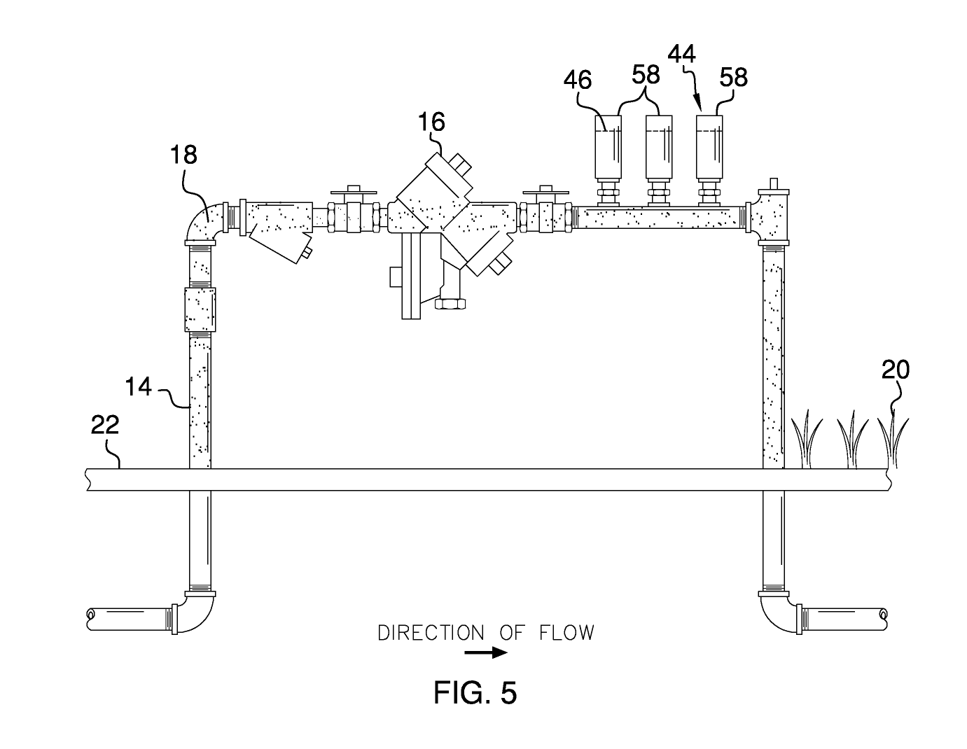

With reference now to the drawings, and in particular to FIGS. 1 through 6 thereof, a new chemical distribution device embodying the principles and concepts of an embodiment of the disclosure and generally designated by the reference numeral 10 will be described.

As best illustrated in FIGS. 1 through 6, the chemical distribution system 10 generally comprises an irrigation unit 12 that has a distribution pipe 14 and a pump 16 fluidly coupled to the distribution pipe 14. The pump 16 urges a liquid 18 through the distribution pipe 14 and the irrigation unit 12 delivers the fluid 18 onto a plant crop 20. The fluid 18 may be water and the distribution pipe 14 may be buried beneath ground 22. The plant crop 20 may be a lawn. The pump 16 may be a fluid pump that is fluidly attached to the distribution pipe 14 or the pump 16 may be an electrical fluid pump that is remotely located with respect to the distribution pipe 14.

The distribution pipe 14 has an exposed section 24 and the exposed section 24 comprises a pair of upright pipes 26 fluidly coupled to and extending upwardly from the distribution pipe 14. Each of the upright pipes 26 has a distal end 28 with respect to the distribution pipe 14 and the distal end 28 of each of the upright pipes 26 is exposed above ground 22. A central pipe 30 is fluidly coupled between the distal end 28 of each of the upright pipes 26 and the central pipe 30 has a port 32 coupled thereto. A plurality of fittings 34 is provided and each of the fittings 34 fluidly couples the central pipe 30 to the distribution pipe 14.

A box 36 is provided that has a top side 38 and a bottom side 40. The bottom side 40 is open and the top side 38 has an opening 42 extending therethrough. The bottom side 40 may be placed on the ground 22 and the box 36 is positioned to surround the exposed section 24 having the opening 42 being aligned with the port 32.

An injector 44 is fluidly attached to the irrigation unit 12 and the injector 44 contains a chemical 46. The chemical 46 may be a liquid plant fertilizer, a liquid insecticide or other chemical utilized in the convention of crop maintenance. The injector 44 is oriented such that the chemical 46 is gravity fed into the irrigation unit 12. The injector 44 releases the chemical 46 into the fluid 18 urged by the pump 16 such that the chemical 46 and fluid 18 mixture is delivered onto the plant crop 20.

The injector 44 comprises a container 48 that has a top end 50, a bottom end 52 and a peripheral wall 54 extending between the top end 50 and the bottom end 52. The container 48 is substantially hollow and the container 48 contains the chemical 46. The bottom end 52 has a nozzle 56 fluidly attached thereto and the nozzle 56 is in fluid communication with an interior of the container 48. The container 48 is directed through the opening 42 in the box 36. The nozzle 56 threadably engages the port 32 on the central pipe 30 such that the container 48 is placed in fluid communication with the central pipe 30. The nozzle 56 releases the chemical 46 into the fluid 18 in the central pipe 30 thereby facilitating the irrigation system 12 delivering the chemical 46 to the plant crop 20.

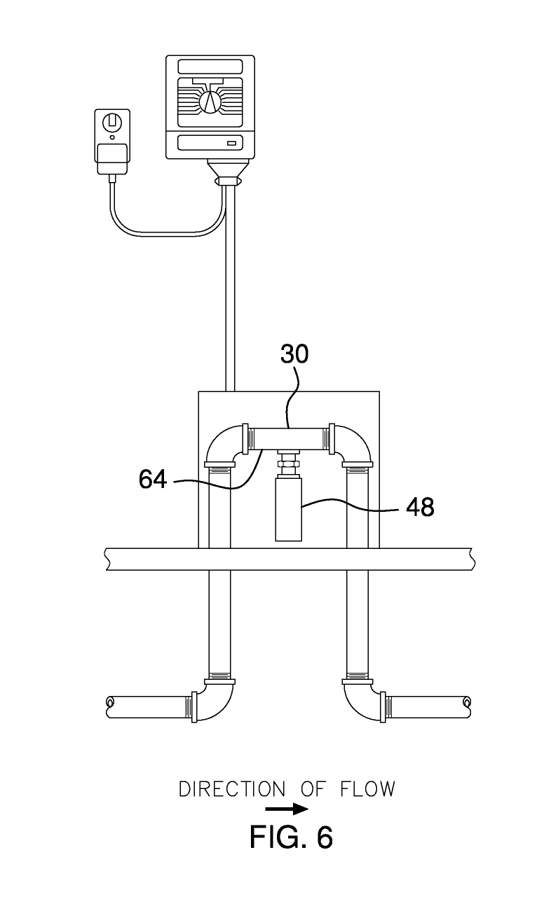

The container 48 may be one of a plurality of containers 58 and the port 32 may be one of a plurality of ports 60. The opening 42 in the box 36 may be one of a plurality of openings 62 that are each aligned with one of the ports 60. Each of the containers 58 may be directed through one of the openings 62 such that the nozzle 56 on each of the containers 58 threadably engages an associated one of the ports 60. Additionally, each of the containers 58 may contain a unique chemical 46 thereby facilitating a combination of various chemicals 46 to be mixed with the fluid 18. In an alternative embodiment as shown in FIG. 6, the container 48 may be positioned on a bottom 64 of the central pipe 30. A suction of the fluid 18 flowing through the central pipe 30 may draw the chemical 46 outwardly from the container 48.

In use, the container 48 is positioned such that the nozzle 56 threadably engages the port 32 in order to mix the chemical 46 with the fluid 18. The injector 44 facilitates the irrigation unit 12 to distribute the chemical 46 on the plant crop 20 thereby eliminating the necessity to manually apply the chemical 46 to the plant crop 20. The container 48 is replaced or refilled once the chemical 46 within the container 48 is depleted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A chemical distribution system configured to selectively release chemicals into an irrigation system, said system comprising:
an irrigation unit having a distribution pipe and a pump fluidly coupled to said distribution pipe, said pump being configured to urge a liquid through said distribution pipe, said irrigation unit being configured to deliver the fluid onto a plant crop;
an injector fluidly attached to said irrigation unit, said injector being configured to contain a chemical, said injector being oriented such that the chemical is gravity fed into said irrigation unit, said injector releasing the chemical into the fluid urged by said pump such that the chemical and fluid mixture is delivered onto the plant crop, wherein said injector comprises a container having a top end, a bottom end and a peripheral wall extending between said top end and said bottom end, said container being substantially hollow, said container being configured to contain the chemical, said bottom end having a nozzle fluidly attached thereto, said nozzle being in fluid communication with an interior of said container;
said irrigation unit including a central pipe having a port;
a box having an opening, said box being positioned around said central pipe, said opening being aligned with said port; and
said container being directed through said opening in said box, said nozzle threadably engaging said port on said central pipe such that said container is placed in fluid communication with said central pipe, said nozzle being configured to release the chemical into the fluid in said central pipe wherein said irrigation system delivers the chemical to the crop.

2. The system according to claim 1, wherein said distribution pipe is configured to be buried beneath ground, said distribution pipe having an exposed section, said exposed section comprising a pair of upright pipes fluidly coupled to and extending upwardly from said distribution pipe, each of said upright pipes having a distal end with respect to said distribution pipe, said distal end of each of said upright pipes being exposed above ground, said central pipe being fluidly coupled between said distal end of each of said upright pipes.

3. The system according to claim 2, further comprising said box having a top side and a bottom side, said bottom side being open, said top side having said opening extending therethrough, said bottom side being configured to be placed on the ground, said box being positioned to surround said exposed section.

4. (canceled)

5. (canceled)

6. A chemical distribution system configured to selectively release chemicals into a irrigation system, said system comprising:
an irrigation unit having a distribution pipe and a pump fluidly coupled to said distribution pipe, said pump being configured to urge a liquid through said distribution pipe, said irrigation unit being configured to deliver the fluid onto a plant crop, said distribution pipe being configured to be buried beneath ground, said distribution pipe having an exposed section, said exposed section comprising a pair of upright pipes fluidly coupled to and extending upwardly from said distribution pipe, each of said upright pipes having a distal end with respect to said distribution pipe, said distal end of each of said upright pipes being exposed above ground, a central pipe fluidly coupled between said distal end of each of said upright pipes, said central pipe having a port coupled thereto;
a box having a top side and a bottom side, said bottom side being open, said top side having an opening extending therethrough, said bottom side being configured to be placed on the ground, said box being positioned to surround said exposed section having said opening being aligned with said port; and
an injector fluidly attached to said irrigation unit, said injector being configured to contain a chemical, said injector being oriented such that the chemical is gravity fed into said irrigation unit, said injector releasing the chemical into the fluid urged by said pump such that the chemical and fluid mixture is delivered onto the plant crop, said injector comprising a container having a top end, a bottom end and a peripheral wall extending between said top end and said bottom end, said container being substantially hollow, said container being configured to contain the chemical, said bottom end having a nozzle fluidly attached thereto, said nozzle being in fluid communication with an interior of said container, said container being directed through said opening in said box, said nozzle threadably engaging said port on said central pipe such that said container is placed in fluid communication with said central pipe, said nozzle being configured to release the chemical into the fluid in said central pipe wherein said irrigation system delivers the chemical to the crop.
